(19) United States
(12) Patent Application Publication
(10) Pub. No.: US 2008/0148223 A1
(43) Pub. Date: Jun. 19, 2008

(54) System for defining a declarative language

(76) Inventors: Milind Arun Bhandarkar, San Jose, CA (US); Sameer Paranjpye, Sunnyvale, CA (US)

Correspondence Address: BRINKS HOFER GILSON & LIONE / YAHOO! OVERTURE, P.O. BOX 10395, CHICAGO, IL, 60610, US

(21) Appl. No.: 11/641,648

(22) Filed: Dec. 19, 2006

(51) Int. Cl. G06F 9/44; G06F 7/00

(52) U.S. Cl. 717/106; 707/102; 707/E17.048

(57) ABSTRACT

A system is disclosed for generating source code for implementing a declarative language. A first set of information defining at least one data entity for use in a new declarative language may be received, the at least one data entity having an associated type. A second set of information defining translation requirements may be received for translating the at least one entity to a source code representation of the at least one data entity. Based on the associated type of the at least one data entity and the translation requirements, the data entity may be translated into a source code representation of the data entity.

### BACKGROUND

1. Technical Field

This application relates to methods and systems, generally referred to as systems, for defining declarative languages. More particularly, this application relates to a flexible approach for defining a declarative language using existing dynamic languages.

2. Related Art

Declarative languages, such as data definition languages (DDL), may be widely created and used by programmers to simplify a process by which a programmer can implement particularized tasks. For example, many declarative languages are developed to transfer data into and out of storage solutions and application programs, a process is known as serialization and deserialization of data. By creating the declarative language, the programmer may subsequently invoke simple, high level commands to retrieve and/or store complex data objects from and/or to a database. For example, Structured Query Language (SQL) commands, such as create, alter, and the like, provide an easy way for a programmer to work with data in a SQL database.

To create a new declarative language, however, a programmer may need to embark on an elaborate process that includes defining the syntax and semantics of the declarative language. Known processes may seem fairly straightforward, but they may be time consuming and require the programmer to know additional languages used to define the grammar of the new declarative language. Additionally, such processes may require additional processing time and resources to analyze and determine tokens and create a parse tree. Moreover, such processes may need to be repeated for every declarative language a programmer wishes to create. As a result, programmers may be unable to quickly and easily define a new declarative language. Additionally, programmers may be unable to reuse features and commands of existing declarative languages.

### BRIEF SUMMARY

A method is disclosed for generating source code for implementing a declarative language is provided. The method may include receiving a first set of information defining at least one data entity for use in a new declarative language, the at least one data entity have an associated type, receiving a second set of information defining translation requirements for translating the at least one entity to a source code representation of the at least one data entity, and translating, based on the associated type of the at least one data entity and the translation requirements, the data entity into a source code representation of the data entity.

A system is disclosed for generating source code for implementing a declarative language is provided. The system may include a standard data type translation file defining translation requirements for translating a plurality of standard data types into source representations of the data type, an API analysis file that may define a standard data model for specifying a data entity for use with a new declarative language, and a translation tool adapted to, based on the standard data type translation file and the API analysis file, translate the data entity into a source code representation of the data entity.

These and other aspects are described with reference to the noted Figures and the below detailed description of the preferred embodiments.

### BRIEF DESCRIPTION OF THE DRAWINGS

FIG. 1 is an exemplary diagram detailing processes for defining declarative languages;

FIG. 2 is a flow chart of an exemplary alternative process for defining and creating a declarative language;

FIG. 3 is a flow chart of an exemplary process for defining the entities of a declarative language in dynamic language code;

FIG. 4 is a diagram of an exemplary data API for defining the data entities of a declarative language; and

FIG. 5 is a diagram of the functional elements of an exemplary toolkit for allowing a programmer to create a declarative language.

### DETAILED DESCRIPTION

Systems and methods, generally referred to as systems, are disclosed for defining a declarative language. Existing technologies may limit the manner in which programmers are able to define declarative languages by requiring lexical and syntactic analysis and corresponding specification files.

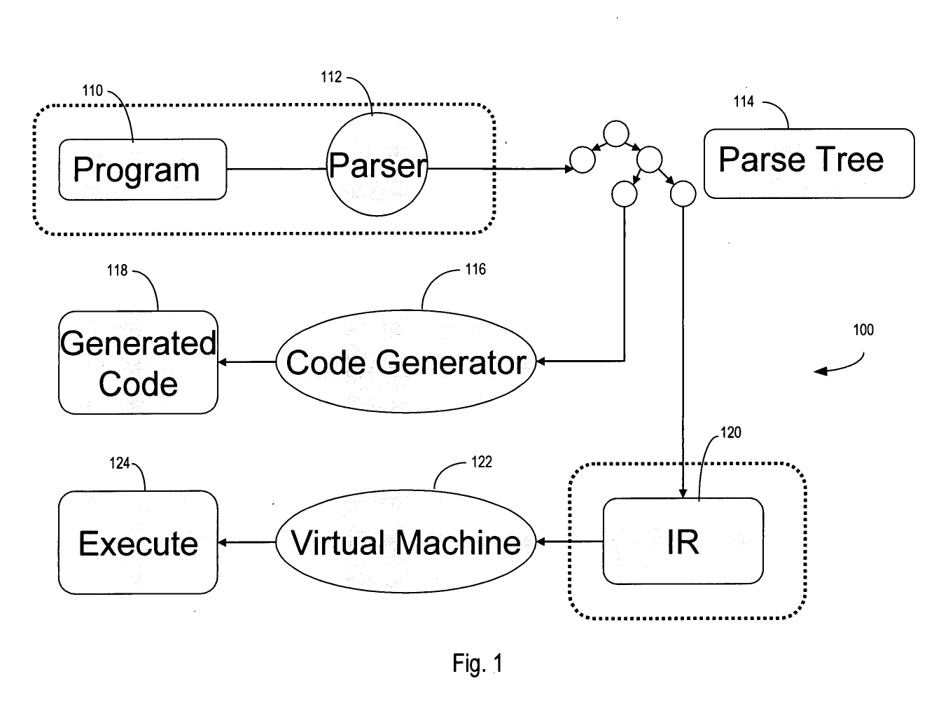

FIG. 1 is an exemplary diagram detailing processes 100 for defining declarative languages. The programmer may first write a program 110 that utilizes the new declarative language. To use the program 110, the program 110 may first be broken down into a series of lexical tokens that are passed to a parser 112, which organizes the tokens into a parse tree 114. The generated parse tree 114 may then be used to generate additional source code that may be used to implement the declarative language. This generated code may then either be passed to a code generator 116 which compiles the generated code into an executable program 118, or translated into an intermediate representation 120 which is used in conjunction with a virtual machine 122 to provide an executable program 124.

The program 110 may or may not be lexically or syntactically analyzed until the programmer also may define the grammar of the new declarative language using other languages, such as lex and yacc. As used in the art, lex may be a lexical analyzer that uses pattern matching to break down the program into a series of lexical tokens. To determine the tokens, the lex program requires an additional configuration file that may define the patterns corresponding to particular tokens. The token series may then be passed to a parser, such as one generated by parser generation tool yacc, which also requires a configuration file that may define the syntax of the declarative language to assemble the tokens into the parse tree 114.

The systems described herein may allow a flexible way for programmers to quickly and easily define the data entities for use with the new declarative language and automatically generate code for implementing the new language without requiring the programmer to define the syntax of the new language. Additionally, the systems described herein can reuse existing code defining a declarative language using object oriented programming features. Although reference is made below to specific components of the system performing specific features, it should be apparent that such reference is exemplary, is not intended to limit the scope of the claims in any way, and that the functionalities described herein may be implemented in a virtually unlimited number of configurations.

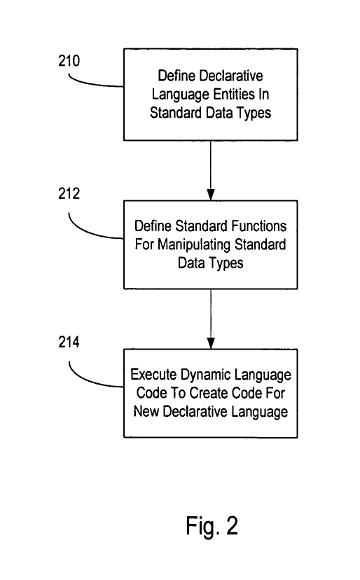

In FIG. 2, a flow chart illustrates an exemplary process for defining and creating a declarative language. The programmer may define the data elements for use by a new declarative language using native data entities of an existing programming language at 210. The data entities of the new language may include one or more primitive or complex data entities that define the data to be used by the new declarative language. For example, a declarative language for working with information relating to IP addresses may include a complex data entity for maintaining an IP address and the number of hosts and domains associated with that address, each of which may be represented using native primitive data types such as integers, bytes, and the like.

The data entities of the new declarative language (new data entities) may be defined using complex and primitive data types of an existing programming language (existing data types). The existing data types may be standard data types of the existing language, or may be user defined data objects. An exemplary set of primitive and complex data types for use in defining a new declarative language and their corresponding C++ and JAVA equivalents are shown in Tables 1 and 2, respectively.

TABLE 1
Exemplary Primitive Data Types

| Data Type | C++ Equivalent | JAVA Equivialent |
|---|---|---|
| Byte | uint8_t | byte |
| Bool | bool | boolean |
| int32 | int32_t | int |
| int64 | int64_t | long |
| Float | float | float |
| Double | double | double |
| String | std::string | java.lang. String |
| Buffer | (void*, size_t) | byte[ ] |

TABLE 2
Exemplary Complex Data Types

| Data Type | C++ Equivalent | JAVA Equivialent |
|---|---|---|
| Vector | vector<T> | java.util.Vector |
| record | class T | class T |

The existing programming language may be a dynamic programming language. As used herein, a dynamic programming language is a language which allows for, during runtime, the addition of new code, the extension of objects and definitions, and/or modification of the type system. An exemplary dynamic language for use in defining a declarative language is Python, created by Guido van Rossum and currently developed by the Python Software Foundation. By defining the new declarative language in terms of entities of a dynamic language, the system may allow for a more flexible manner of extending created declarative languages that have already been defined in terms of the dynamic language.

After defining the new declarative language using the standard data types, predefined functions in the destination programming language for working with the standard types may be created at 214. The predefined functions may define standard functions for dealing with data of a given type, and may be used to implement any function desired of the new declarative language. In other words, the standard functions may include an API for defining the new language. Exemplary predefined functions for a declarative language for storing and retrieving data may include accessor and acceptor functions for use by a program 110 to access data, serialization and deserialization functions for working with a data store, and the like. Other functions for manipulating data in any way may also be used.

The predefined functions and data entity definitions may be used to generate code to implement in another programming language at 216. For example, class definitions may be created in the destination programming language for the data entities that define the data entities and functions used to manipulate those entities. These classes may then be easily incorporated into an existing application framework to extend the functionalities of the framework to utilize the newly created declarative language. Code to implement the new declaratively language may be generated in any language, such as C, C++, C#, JAVA, and the like. Exemplary generated code in C++ for a data entity of the type “int32” named DataEntityOne is shown in Table 3.

TABLE 3
Exemplary Generated C++ Code For Int32 Data Type

```
. . .
private:
  int32_t mDataEntityOne
. . .
public:
  const int32_t& getDataEntityOne ( ) const {
    return mDataEntityOne
  };
  void setDataEntityOne(const int32_t &m) {
    mDataEntityOne = m;
  };
. . .
```

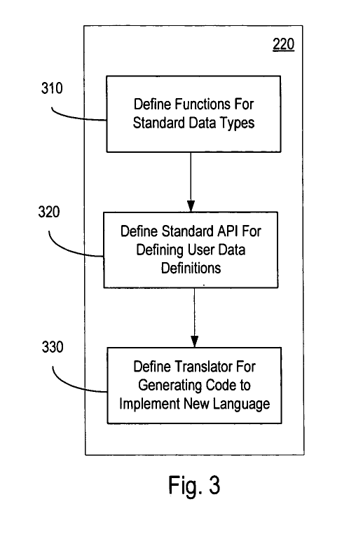

FIG. 3 is a flow chart of an exemplary process for defining a set of standard functions (220) for use in defining a new declarative language. The processes may be defined using a dynamic language, as described above. Initially, a series of functions for manipulating standard data types, such as the standard data types identified in Table 1 and 2, are defined at 310. The functions may include data and function declarations in the destination source code that may be created whenever a data entity of the corresponding type is defined by the programmer for the new declarative language. For example, functions for manipulating primitive data types such as integers may include a declaration of the integer in the destination language, and functions for retrieving the value of the integer, setting the value of the integer, and the like. Similarly, functions for manipulating complex data types may also be created. Exemplary Python code including functions for declaring primitive and complex data types in C++ is shown in Table 4. Other languages may also be used.

TABLE 4
Exemplary Functions For Manipulating Standard Data Types

```
import sys
class jtype (dict):
  def _init_{—} (self, name, size, langtypes) :
    self.name = name
    self.size = size
    dict._init_(langtypes)
  def getName (self) :
    return self.name
  def getSize (self) :
    return self.size
  def getLangType (self, language) :
    if not self.has_key(language) :
      print >> sys.stderr, “Target Language %s not supported.
      Exiting.\n” % \
        (language)
      sys.exit(1)
    return self[language]
class String (jtype) :
  def _init_{—} (self) :
    jtype._init_(self, “string”, 0, {“C++”:“std::string”})
string = String( )
class Md5 (jtype) :
  def _init_{—} (self) :
    jtype._init_(self, “md5”, 16, {“C++”:“jtapi::md5”})
md5 = Md5( )
class Uint8_t (jtype) :
  def _init_{—} (self) :
    jtype._init_(self, “uint8”, 1, {“C++”:“uint8_t”})
uint8 = Uint8_t( )
class Uint16_t (jtype) :
  def _init_{—} (self) :
    jtype._init_(self, “uint16”, 2, {“C++”:“uint16_t”})
uint16 = Uint16_t( )
class Uint32_t (jtype) :
  def _init_{—} (self) :
    jtype._init_(self, “uint32”, 4, {“C++”:“uint32_t”})
uint32 = Uint32_t( )
class Uint64_t (jtype) :
  def _init_{—} (self) :
    jtype._init_(self, “uint64”, 8, {“C++”:“uint64_t”})
uint64 = Uint64_t( )
class Int8_t (jtype) :
  def _init_{—} (self) :
    jtype._init_(self, “int8”, 1, {“C++”:“int8_t”})
int8 = Int8_t( )
class Int16_t (jtype) :
  def _init_{—} (self) :
    jtype._init_(self, “int16”, 2, {“C++”:“int16_t”})
int16 = Int16_t( )
class Int32_t (jtype) :
  def _init_{—} (self) :
    jtype._init_(self “int32”, 4, {“C++”:“int32_t })
int32 = Int32_t( )
class Int64_t (jtype) :
  def _init_{—} (self) :
    jtype._init_(self, “int64”, 8, {“C++”:“int64_t”})
int64 = Int64_t( )
class Float32_t (jtype) :
  def _init_{—} (self) :
    jtype._init_(self, “float32”, 4, {“C++”:“float”})
float32 = Float32_t( )
class Float64_t (jtype) :
  def _init_{—} (self) :
    jtype._init_(self, “float64”, 8, {“C++”:“double”})
float64 = Float64_t( )
class Vector (jtype) :
  def _init_{—} (self, elem, len = 0) :
    if not isinstance (elem, jtype) :
      print >> sys.stderr, “Illegal type \“%s\”. Exiting.” % str(name)
        sys.exit(1)
    if len == 0 :
      jtype._init_(self, “Vector (%s)” % elem.getName( ), 0,\
          {“C++”:“std::vector<%s>” % elem.getName( )})
    else :
      jtype._init_(self, “%s[%d]” % (elem.getName( ),len), \
          elem.getSize( )*len, {“C++”:“std::vector<%s>”
          % elem.getName( )})
```

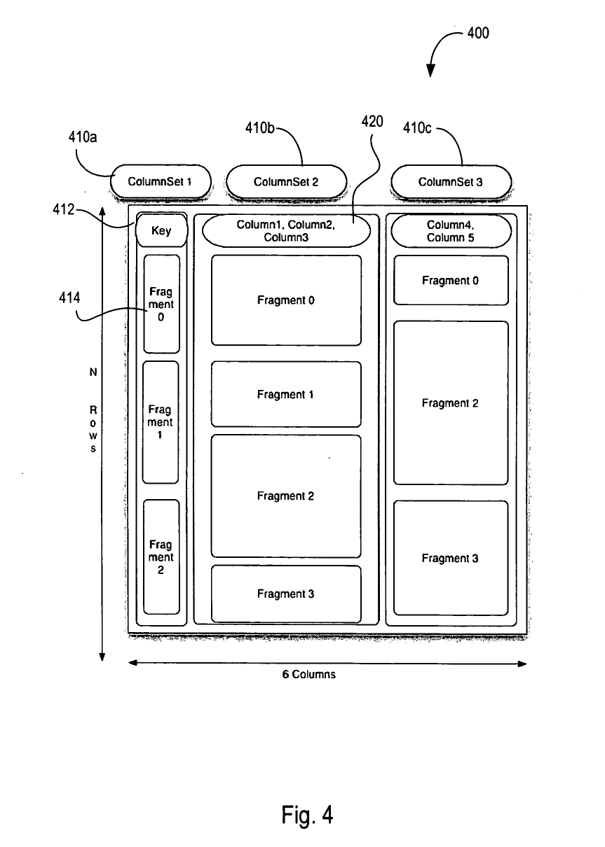

Functions defining an API to the system may be created at 320. These functions may include the definition of a standard data model used to define the data entities of the new declarative language and functions for how to interpret the standard data model to generate code in the destination language based on the programmer defined data entities. An exemplary data model defining an API for defining a new declarative language is show in FIG. 4. The data model may include a single table 400 that includes one or more column sets 410a, 410b, and 410c (generally referred to as 410). Each column set 410 may refer to related columns 420, where each column 420 may define a single data element of a specified type. Additionally, each column set 410 may also include one or more fragments 414 that define metadata associated with the column set, such as attributes about the data contained in the column set. Each table may have a single column act as the key 412 for the table, providing a unique identifier for the records contained in the table.

Optionally, views of the data contained in the table may also be created to allow a mechanism for collating information from multiple column sets may also be included. Typically, views may be used only to retrieve data, and therefore, only accessor functions to obtaining the data specified in the view may be generated in the destination programming language. Alternatively, any type of function, including acceptor functions may also be generated in the destination programming language for views.

An exemplary table definition for a table including data relating to IP address is shown in Table 5. The table may include documentation information for the table. Additionally, a column set definition statement defining the column sets included in the table. For example, the Table 5 includes an IpInfo columnset, a HostVec columnset, and a DomainVec columnset. The column set definitions may be included in the same file as the table definition, or may be included by reference as illustrated in Table 5. Finally, a view definition statement defining the views included in the table may also be included in the table definition.

TABLE 5
Exemplary Table Definition

```
include (“../csets/ipinfo”)
include (“../csets/hostvec”)
include (“../csets/domainvec”)
Table ( “IpTable”,
  doc = “Host names and Domain names hosted for each IP address.”,
  columnsets = [IpInfo, “HostVec”, “DomainVec” ]
  views = [
    ( “IpHosts”, [ IpInfo.IP, IpInfo.numHosts, HostVec.hosts ] ),
    ( “IpDomains”, [ IpInfo.IP, IpInfo.numDomains,
    DomainVec.domains ])
  ]
)
```

Exemplary column set definitions are shown in Table 6. Each column set definition may describe the columns of the column set. Multiple column sets may be defined in a single file, or each column set may be defined in a separate file. Each column set definition may include documentation information relating to the column set, and a list of the columns included in the column set. For example, an IpInfo columnset may include columns defining an IP address, the number of Uniform Resource Locators (URLs) associated with the address, and the number of hosts associated with the address. The columns may be defined explicitly in the column set definition, as illustrated in Table 6, or may be included in separate files. For example, each column may be defined as having a particular data element having a name and a data type selected from the standard data types identified above. Additionally, attributes such as compression information that indicates which method if any is used to compress the columnsets, order information that indicates how the columns are ordered and the like may also be defined in the column set definition.

TABLE 6
Exemplary Column set Definitions

```
ColumnSet ( “IpInfo”,
  doc = “Summary hosting data for each IP address.”,
  columns = [ (“IP”, uint32),
        (“numUrls”, uint32),
        (“numHosts”, uint32),
        (“numDomains”, uint32)
        ],
  key = “IP”,
  attributes = [
    (“compression”, “None”),
    (“order”, “Column”)
  ]
)
ColumnSet ( “HostVec”,
  doc = “Hosts pointing to this IP address”,
  columns = [ (“hosts”, Vector(string)) ],
  attributes = [ (“compression”, “Block”) ]
)
ColumnSet ( “DomainVec”,
  doc = “Domains hosted on this IP address”,
  columns = [ (“domains”, Vector (string)) ],
)
```

Once a standard data model is established for defining the data entities of the new declarative language, code may be defined for accessing and analyzing the standard data model. For example, code may be generated to interpret the table definitions (including column set and column definitions) described above, and generate the corresponding destination language code. Exemplary Python code including functions for analyzing a table definition is shown in Table 7.

TABLE 7
Exemplary Functions For Analyzing Table Definition

```
import sys
import os
from jtypes import *
# cache away the main module dictionary
_mmd = sys.modules[‘_main_’]._dict_{—}
def include (path):
  f = None
  try :
    f = file (path, ‘r’)
  except IOError, detail :
    print >> sys.stderr, “Cannnot open included file %s.
    Exiting.” % (path)
    sys.exit(1)
  try :
    ldir = os.getcwd( )
    ddir = os.path.dirname(path)
    os.chdir(ddir)
    exec f in _mmd
    os.chdir (ldir)
  except Exception, detail :
    print >> sys.stderr, “Error in including file %s.\nDetail:
    %s\nExiting.” % \
            (f.name, detail)
    sys.exit(1)
  f.close( )
def checkName (name) :
  if name == “”:
    return False
  else:
    return True
# create cset dictionary unless already created
if not _mmd.has_key(‘_csets’) :
  _mmd[‘csets’]= { }
_csets = _mmd[‘_csets’]
# create table dictionary unless already created
if not _mmd.has_key(‘_tables’) :
  _mmd[‘_tables’] = { }
_tables = _mmd[‘_tables’]
class Column :
  def _init_(self, name, type, doc=“”) :
    if not checkName (name) :
      print >> sys.stderr, “Illegal name \“%s\” for a column.
      Exiting.” % \
            name
      sys.exit(1)
    if not isinstance (type, jtype) :
      print >> sys.stderr, “Illegal type \“%s\” for a column. Exiting.” % \
            str(type)
      sys.exit(1)
    self.type = type
    self.name = name
    self.doc = doc
  def getName (self) :
    return self.name
  def getType (self) :
    return self.type
  def getDoc (self) :
    return self.doc
class ColumnSet :
  def _init_(self, name, doc=“”, columns=[ ], key=[ ], attributes=[ ]):
    # first check if name is proper
    if not checkName (name) :
      print >> sys.stderr, “Illegal name \“%s\”for a columnset.
      Exiting.” % \
            name
      sys.exit(1)
    # has it already been defined as a columnset?
    if _csets.has_key (name) :
      print >> sys.stderr, \
        “Duplicate columnset definition for \“%s\”. Exiting.” % name
      sys.exit(1)
    # has it already been defined as anything else?
    if _mmd.has_key (name) :
      print >> sys.stderr, \
        “Columnset name clashes with other name \“%s\”.
        Exiting.” % name
      sys.exit(1)
    # insert it in _csets and main module
  _csets[name] = self
  _mmd[name] = self
class Table:
  def _init_(self, name, doc=“”, columnsets=[ ], views=[ ]):
    # first check if name is proper
    if not checkName (name) :
      print >> sys.stderr, “Illegal name \“%s\”for a table. Exiting.” % \
            name
      sys.exit(1)
    # has it already been defined as a table?
    if _tables.has_key (name) :
      print >> sys.stderr, \
      “Duplicate table definition for \“%s\”. Exiting.” % name
      sys.exit(1)
    # has it already been defined as anything else?
    if _mmd.has_key (name) :
      print >> sys.stderr, \
        “Table name clashes with other name \“%s\”. Exiting.” % name
      sys.exit(1)
    # insert it in _tables and main module
    _tables[name] = self
    _mmd[name] = self
```

Referring again to FIG. 3, translator code may be defined to automatically generate the destination source code required to implement the new declarative language at 320. The translator code may allow for a series of command line options that allow the user to specify table definition files. Additionally, command line options may be implemented to allow the programmer to specify a desired destination language. For example, a programmer may enter the command “translate TableDefintion-language C++” to translate the table defined in the file TableDefinition into C++ code for implementing the desired declarative language. Alternatively, table definition files and destination languages may be specified in any manner. Exemplary Python code including functions for translating table definitions into C++ is shown in Table 8.

TABLE 8
Exemplary Functions For Translating Table Definition

```
import sys
if sys.path[0] == ” :
  sys.path[0] = “./Actions”
  sys.path.insert(0, “./framework”)
else:
  sys.path.insert(0, sys.path[0] + “/Actions”)
  sys.path.insert(0, sys.path[1] + “/framework”)
import os
import imp
from optparse import OptionParser
from framework import *
usage = “usage: %prog [options] tablefile ...”
def main( ) :
# parse cmdline options
  parser = OptionParser(usage=usage, version=“%prog 0.1”)
  parser.add_option (“-t”, “--table”, metavar=“TABLE”, type=“string”,
    action=“append”, dest=“tables”, help=“Names of the Tables”)
  parser.add_option (“-f”, “--framework”, metavar=“FRAMEWORK”,
type=“string”,
    dest=“framework”,
    help=“Generate code for FRAMEWORK on the TABLE”)
  parser.add_option (“-l”, “--language”, metavar=“LANGUAGE”,
type=“string”,
    dest=“language”,
    help=“Generate code for FRAMEWORK on the TABLE in
LANGUAGE”)
  parser.set_defaults (framework=“MapReduce”, language=“C++”)
  (options, args) = parser.parse_args( )
  params = { }
  if (len(args) == 0) :
    parser.error(“No table file specified. Use --help.”)
# try to open table files
  for name in args :
    include (name)
  print “TableFiles are ”, args
  print “Columnsets are ”, _csets
  print “Tables are ”, _tables
  if options.tables == None or len(options.tables) == 0 :
    jtables = _tables
  else:
    jtables = { }
    for t in options.tables :
      if not_tables.has_key(t) :
        print >> sys.stderr, “Undefned table %s. Exiting.” % (t)
        sys.exit(1)
      jtables[t] = _tables[t]
  for t in jtables.keys( ) :
    print “Invoking %s.gencode(%s,” % (options.framework, t),
    print “language=\“%s\”)” % options.language
if_name_{—} == “_main_”:
  main( )
```

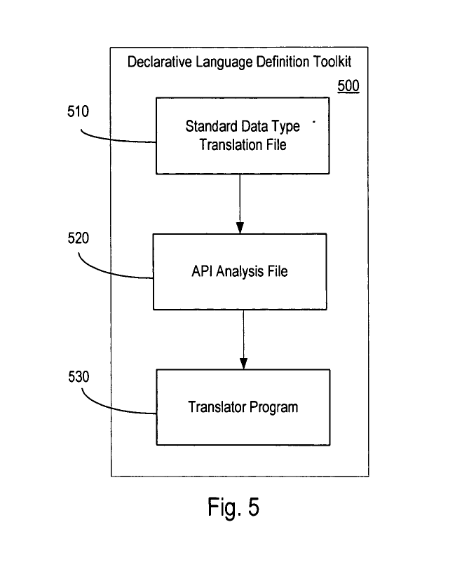

FIG. 5 is a diagram of the functional elements of an exemplary toolkit 500 for allowing a programmer to create a declarative language. The toolkit 500 may include a standard datatype translation file 510 that may define the translation requirements for translating standard data type into a desired destination language, as described above. The toolkit 500 may also include an API analysis file 520 that may define procedures for analyzing an input file defining the data entities of a new declarative language using a predefined API, as described above. Finally, the toolkit 500 may also include a translator program 530 that utilizes the a user specified data entity definition file, the standard data type translation file 510, and the API analysis file 520 to generate code in a destination language to implement a new declarative language. For example, the toolkit 500 may be used to generate C++ code to implement the new declarative language.

An exemplary user specified data entity definition file and subsequently generated C++ code are shown in Tables 9, 10, and 11. As illustrated, a class definition may be created based on the defined data entity (Table 9) and placed in a C++ header file (Table 10). The underlying methods for manipulating the data may be included in a C++ source file, as shown in Table 11. In this example, the data definition is described in a file named “testrec.jr.” Additionally, the toolkit 500 is configured to generate class definitions based on a standard class definition for the standard API data model (referred to as std::Record) and to generate accessor and acceptor functions for retrieving and storing data by a program, as well as serialization and deserialization functions for retrieving and storing data to/from a data store.

TABLE 9
Exemplary Data Definition

```
record (“RI”,
  [ (“I32”, int32),
    (“D”, double),
    (“S”, string)
  ]
)
```

TABLE 10
Exemplary Generated C++ Header File

```
#ifndef TESTREC_JR_HH_{—}
#define TESTREC_JR_HH_{—}
#include “stdrecords.hh”
namespace testrec {
class RI : public std::Record {
  private:
  int32_t mI32;
  double mD;
  std::string mS;
public:
  virtual int32_t getI32( ) const { return mI32; }
  virtual void setI32(int32_t m_) { mI32 = m_; }
  virtual double getD( ) const { return mD; }
  virtual void setD(double m_) { mD = m_; }
  virtual std::string& getS( ) { return mS; }
  virtual void setS(const std::string& m_) { mS = m_; }
  virtual void serialize(std::OArchive& a_,
  const char* tag) const;
  virtual void deserialize(std::IArchive& a_, const char* tag);
  virtual const std::string& type( ) const;
  virtual const std::string& signature( ) const;
  virtual ~RI( ) { }
};
}; // end namespace testrec
#endif /*TESTREC_JR_HH_*/
```

TABLE 11
Exemplary Generated C++ Source File

```
#include “testrec.jr.hh”
void testrec::RI::serialize(std::OArchive& a_,
                const char* tag) const {
  a_.startRecord(*this, tag);
  a_.serialize(mI2, “I32”);
  a_.serialize(mD, “D”);
  a_.serialize(mS, “S”);
  a_.endRecord(*this, tag);
};
void testrec::RI::deserialize(std::IArchive& a_,
                  const char* tag) {
  a_.startRecord(*this, tag);
  a_.deserialize(mI2, “I32”);
  a_.deserialize(mD, “D”);
  a_.deserialize(mS, “S”);
  a_.endRecord(*this, tag);
};
const std::string& testrec::RI::type( ) const
{
  static const std::string type_(“testrec.RI”);
  return type_;
}
const std::string& testrec::RI::signature( ) const
{
  static const std::string signature_(“ids”);
  return signature_;
}
```

It is therefore intended that the foregoing detailed description be regarded as illustrative rather than limiting, and that it be understood that it is the following claims, including all equivalents, that are intended to define the spirit and scope of this invention.

1. A method for generating source code for implementing a declarative language, comprising:
receiving a first set of information defining at least one data entity for use in a new declarative language, the at least one data entity having an associated type;
receiving a second set of information defining translation requirements for translating the at least one entity to a source code representation of the at least one data entity; and
translating, based on the associated type of the at least one data entity and the translation requirements, the data entity into a source code representation of the data entity.

2. The method of claim 1, where the associated type is selected from a plurality of standard data types.

3. The method of claim 2, where the translation requirements define particular translation requirements for each of the plurality of standard data types, and where the translating further includes translating the data entity based on the translation requirements for the standard data entity matching the associated type.

4. The method of claim 2, where the translation requirements define particular functions for manipulating the at least one of the plurality of standard data types.

5. The method of claim 4, where the functions include functions for reading data from a data store.

6. The method of claim 4, where the functions include functions for writing data to a data store.

7. The method of claim 1, further receiving a third set of information defining a desired destination language, and where the translating further includes translating the at least one data entity to source code in the desired programming language.

8. The method of claim 7, where the desired programming language is selected from the group consisting of C, C++, C#, and JAVA.

9. The method of claim 1, further defining a standard data model for defining at least one data entity.

10. The method of claim 9, where the standard data model includes a table for specifying a plurality of data entities, where the table includes one or more column sets that define a set of related information.

11. The method of claim 10, where the table further includes at least one view including information from multiple column sets.

12. A system for generating source code for implementing a declarative language, comprising:
a standard data type translation file defining translation requirements for translating a plurality of standard data types into source representations of the data type;
an API analysis file that defines a standard data model for specifying a data entity for use with a new declarative language; and
a translation tool adapted to, based on the standard data type translation file and the API analysis file, translate the data entity into a source code representation of the data entity.

13. The system of claim 12, where the translation requirements define particular functions for manipulating the at least one of the plurality of standard data types.

14. The system of claim 13, where the functions include functions for reading data from a data store.

15. The system of claim 13, where the functions include functions for writing data to a data store.

16. The system of claim 12, further receiving a set of information defining a desired destination language, and where the translation tool is further adapted to translate the at least one data entity to source code in the desired programming language.

17. The system of claim 16, where the desired programming language is selected from the group consisting of C, C++, C#, and JAVA.

18. The system of claim 12, where the standard data model includes a table for specifying a plurality of data entities.

19. The system of claim 18, where the table includes one or more column sets that define a set of related information.

20. The system of claim 18, where the translation tool is further adapted to translate the data entity into a selected one of a plurality of programming languages.
